(19) United States
(12) Patent Application Publication
(10) Pub. No.: US 2003/0167216 A1
(43) Pub. Date: Sep. 4, 2003

(54) Method and apparatus for tracking fixed assets

(76) Inventors: John S. Brown, Zebulon, NC (US); Dilip Patel, Vestal, NY (US); Diana Sinor, Raleigh, NC (US)

Correspondence Address: Synnestvedt & Lechner LLP, 2600 Aramark Tower, 1101 Market Street, Philadelphia, PA, 19107, US

(21) Appl. No.: 10/086,244

(22) Filed: Mar. 1, 2002

(51) Int. Cl. G06F 17/60

(52) U.S. Cl. 705/30

(57) ABSTRACT

The invention is a method and apparatus for tracking the location of assets, such as capitalized fixed assets, for tax reporting and insurance value reporting purposes. In accordance with the invention, each time a transaction occurs with respect to an asset, a tax location finder routine is performed. The tax location finder routine runs through a hierarchical sequence of queries to attempt to classify the asset as one of a plurality of categories corresponding to a customized audit technique that is likely to be able to derive a location for said asset. If and when the asset is correlated to one of the customized audit techniques, that audit technique is applied to attempt to derive a tax location for the asset. If a location can be derived, the location is reported. If the asset cannot be correlated to one of the customized audit techniques or, if it can be correlated to a customized audit technique, but that audit technique cannot derive a location, an error is reported.

### FIELD OF THE INVENTION

The invention pertains to the tracking of assets. More particularly, the invention relates to the tracking of the physical location of capitalized fixed assets for tax reporting and insurance value reporting purposes.

### BACKGROUND OF THE INVENTION

Corporations and other large scale entities usually attempt to accurately keep track of their capitalized fixed assets (sometimes called fixed capital assets) for several reasons. Capitalized fixed assets are physical properties, including real property and personal property, that typically have a significant value. Capital assets are tangible assets, used in the conduct of business that have an expected useful life of one year or more and typically have significant value. The cost of acquiring a capital asset is depreciated over the useful life of the asset, while non capital assets are expensed in the year in which they are purchased. The major categories of capital assets include categories such as land and land improvements, buildings, building equipment, machinery and equipment, data processing equipment, furniture and fixtures and personal computing equipment.

Capital assets are tracked for tax compliance, insurable values reporting and to maintain strong controls over intellectual property that may be stored on some of the equipment. Several types of taxes are imposed on capital assets and the location of the assets is critical in applying the appropriate tax treatment. These taxes include various state and federal taxes, investment tax credits, personal property taxes (which are assessed annually against the value of the assets), and use taxes which are applied against equipment manufactured by the taxpayer and used internally. Taxes can be assessed at the federal, state, and local levels and tax rates and regulations can vary widely between tax jurisdictions. Failure to accurately track fixed assets can result in tax exposures including interest and penalties for inaccurate reporting and loss of potential tax credits or deductions.

Insurable values reporting is done at a building level and requires accurate information on the location of assets.

Accordingly, corporations (and other entities that pay taxes and/or insure assets) should keep track of the location of capitalized fixed assets for tax and insurance reporting purposes. For large entities such as multinational enterprises (MNEs), the task of tracking the location of capitalized fixed assets can be monumental. This is particularly true with respect to MNEs that have many fixed capital assets that are easily portable and regularly moved, such as data processing equipment, lap top computers, and construction equipment.

Software for fixed asset management for large entities is widely available on the market. SAP AG Systeme, better known simply as SAP, is one software company that offers inter-enterprise software for large scale enterprises that provide the ability to interact with a common corporate database for a comprehensive range of applications, including fixed asset management. Fixed asset management software typically provides the capability to integrate management of fixed assets with accounting, production operations and materials, personnel, plants, and archived documents through the use of one or more databases and/or tables and software application modules for manipulating, cross-referencing and validating the data in the databases and/or tables. Fixed asset management software, therefore, is an example of the software that a corporation may use to track the location of capitalized fixed assets.

Many companies use “off the shelf” fixed asset management software products while other companies use highly customized software to suit their particular needs. Software applications used for tracking the location of capitalized fixed assets have certain shortcoming. Tracking the location of assets is extremely simple in theory as long as a human operator of the software updates the software databases that disclose the location of the asset whenever the asset's physical location changes. However, this does not always happen. Thus, when the corporation runs an batch audit of all of its capitalized fixed assets, as is typically done at regular intervals, such as monthly, it is common to discover a substantial number of assets that have unpopulated data fields or invalid data in data fields, including invalid or empty data for the tax jurisdiction (hereinafter tax jurisdiction code data field). It would then be incumbent upon the auditors to fill in or correct the invalid or non-existent data before the audit can be successfully completed.

Accordingly, it is an object of the present invention to provide an improved method and apparatus for tracking the physical location of assets.

### SUMMARY OF THE INVENTION

The invention is a method and apparatus that can be implemented as a software program (or a software module of a larger software program) for determining tax location information with respect to assets such as capitalized fixed assets. In accordance with the invention, the software of the present invention is integrated into a larger software system that includes software modules (herein termed controllers) within which transactions concerning assets are recorded. The inventive software is integrated with the controller software modules so that, when a transaction (e.g., a transfer, capitalization or update) concerning a particular asset is recorded in a controller software module, that controller software module calls the tax location finder module of the present invention and provides the tax location finder module with the transaction record. The inventive tax location finder module then runs through a hierarchical sequence of checks or queries using the information assigned to the asset. In each query, the tax location finder module will check to determine if the data assigned to the asset meets a set of criteria (one or more criterion) that helps indicate a particular routine (or audit) that will probably be able to derive the location of the asset (for tax, insurance or other reporting purposes). Such criteria typically might comprise conditions that indicate the type of the asset (e.g., manufacturing equipment vs. real estate vs. furniture) and/or the nature of the asset's use (e.g., internal vs. customer site vs. loaner vs. vendor site equipment) and/or the building, employee or cost center to which the asset is assigned.

If the data associated with the asset meets the set of criteria for a particular audit, then that audit routine will be called. If the asset does not meet the query criteria for an audit, then it will continue on to the next sequential query until it encounters a query whose criteria it meets. When the asset meets the set of criteria for a particular audit, the audit is called. Each audit is customized to the asset or transaction qualities that caused it to meet the criteria for calling that audit so that the logic in that routine will likely be able to derive a location for that asset. In a preferred embodiment of the invention, the queries at the front of the routine are very specific and they become more general as one goes down the hierarchy.

The called audit checks through the data available in the transaction record and/or one or more tables or databases with asset information that are maintained by the corporation and to which the tax location finder module has access to derive the location of the asset.

In a preferred embodiment of the invention, once an audit is called, there are two possible results. First, if the audit routine discovers sufficient data to derive a tax jurisdiction code, then the derived tax jurisdiction code is passed back to calling controller. The audit logic may also pass back additional location related information, such as the building number, work location and a location type that indicates the source table from which the tax jurisdiction was obtained. The second possibility is that the audit could not successfully derive a tax jurisdiction from the available information due, for example, to invalid data in the transaction record or on a table called in the routine. In this case, the transaction record is sent to an error correction facility where they are manually researched and corrected.

In some embodiments, a third result may be allowed. For instance, depending on the particular audit, there may be circumstances where a transaction record causes an audit to be invoked and that audit cannot derive a location for the asset, but the condition that precipitated the failure to derive a tax location is not necessarily an error that needs correction. Rather, the failure to derive a location may be the result of selecting that audit incorrectly, but a subsequent audit in the hierarchy may still be able to successfully derive a location, if given the opportunity. Accordingly, one or more audit routines may be designed to return the record transaction back into the hierarchy of queries if the audit fails for certain reasons.

### BRIEF DESCRIPTION OF THE DRAWINGS

FIG. 1 is a flow diagram illustrating operation in accordance with the method and apparatus of the present invention.

### DETAILED DESCRIPTION OF THE INVENTION

In accordance with the present invention, whenever a transaction, such as a transfer, capitalization or update, occurs with respect to a fixed capital asset, a routine is performed with respect to that asset to attempt to assign a location to that asset for tax and/or insurance reporting purposes. The invention is best implemented by (and will be described hereinbelow in connection with an embodiment implemented by) software, and particularly by software that is integrated into a larger software system in which transactions relating to capital assets are recorded. However, a process in accordance with the present invention can be implemented in any number of other ways. In a preferred embodiment of the invention, a tax location finder software module (or routine) in accordance with the present invention is called by one or more other software modules that record transactions relating to capital assets whenever the other software module(s) is invoked in connection with a transaction pertaining to a capital asset. The tax location finder module determines a tax location for the asset, if possible, and returns it to the calling controller module. Alternately, the tax location finder module can write the location directly to an appropriate database or table. If a location cannot be determined, it instead returns an error message to the calling controller or to a different software module that may alert a human operator of the failure.

It should be understood that the term “new tax location” as used above does not necessarily mean that the tax location data that previously existed for the asset is necessarily changed. Specifically, any given transaction may result in the derivation of a tax location that is the same as the previous tax location assigned to that asset (and presumably stored in an asset database) since not all transactions result in a change in the physical or tax location of an asset.

Thus, in accordance with the invention, incorrect data or the absence of data as to the tax location of an asset is not allowed to persist for a lengthy period of time. Rather, any time a transaction concerning a fixed capital asset occurs, its tax location is updated either automatically in accordance with the operation of the present invention or manually if the present invention cannot do so automatically. By forcing, or at least bringing to the attention of the responsible individuals, the asset location issue each time a transaction occurs concerning an asset, it helps prevent the accumulation of assets with invalid or empty tax jurisdiction code fields between the periodic running of the tax or insurance value reports.

The present invention provides several advantages over existing products and processes. It assigns a tax location at the initial capitalization of the asset and re-derives the location each time the asset is updated, transferred or has additional capitalizations posted to it. This prevents the accumulation of erroneous data such as invalid buildings in the fixed asset records. It also provides an advantage over batch processing in that information is updated at the time a transaction occurs, rather than a point in time, such as a monthly batch job. The tool is flexible and can be customized to the requirements of the using company based on either the type of equipment being tracked of the use of the equipment.

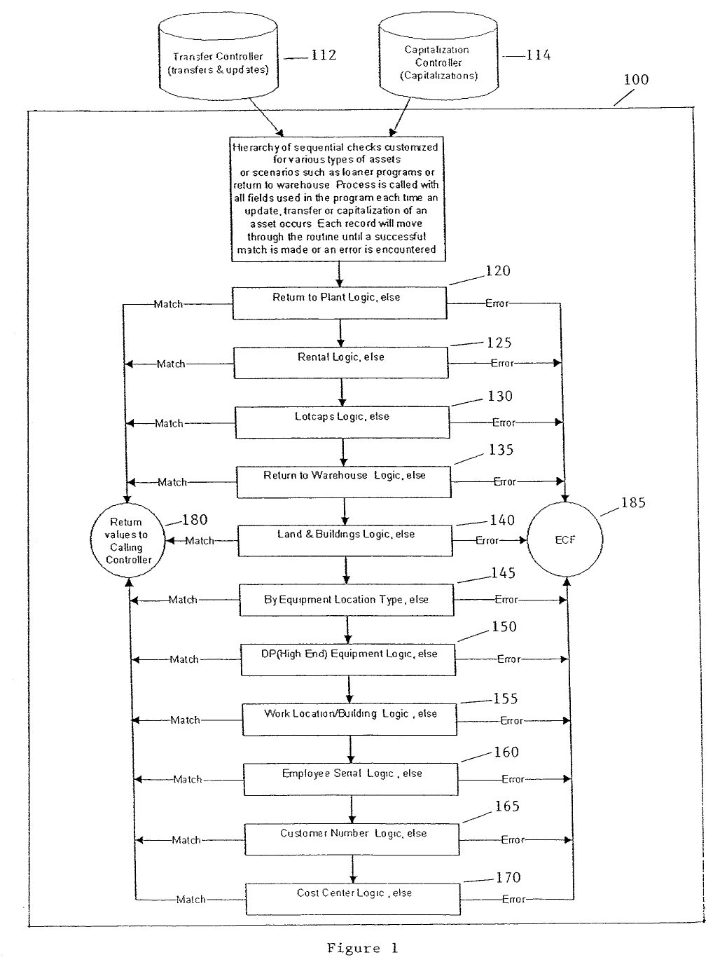

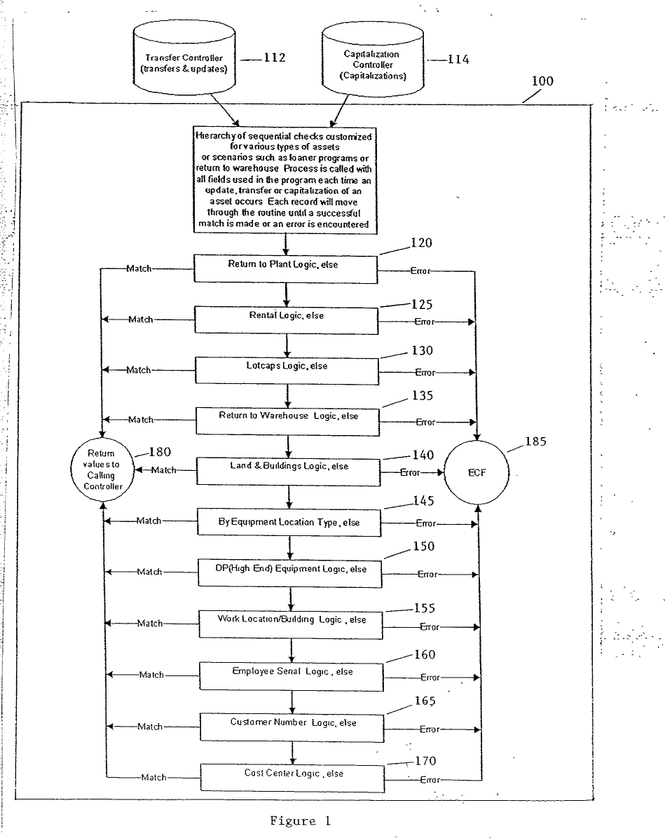

FIG. 1 is a flow chart illustrating operation of a software module 100 in accordance with one particular embodiment of the present invention. The processing flow illustrated in FIG. 1 is invoked every time a record pertaining to any asset is updated via a mechanism which can be detected by the software module 100. Accordingly, in any given particular implementation, the mechanism by which the module is invoked and how accurate that mechanism can depend on the level and manner of integration of the software module with other fixed asset management software modules. Typical updates of an asset that might result in invocation of the inventive software module include an update of an asset in a property control front end application program, update in a cost center maintenance software module, an asset class transfer, initial as well as additional or re-capitalization of an asset, and transfer of an asset to a different assigned location or assigned owner or assigned responsible employee. In a preferred embodiment of the invention, the tax location finder module is invoked by being called by the controller software module that records ro performs or is otherwise made aware of a transaction involving a fixed capital asset. FIG. 1 illustrates this concept with the invention integrated into an overall fixed asset management software system having two front end controller software modules that can record or perform a transaction that results in a change in the tax location of a fixed capital asset. The first is a transfer controller and/or database 112 which, presumably, maintains and controls data for individual fixed assets relevant to transfers and updates of those assets. A separate controller/database 114 is illustrated for capitalization events. However, this separation is merely exemplary and there can be any number of different databases, controller modules, etc., that can invoke the software module of the present invention. The inventive software module can interface with the controller software modules in any reasonable fashion. In one embodiment of the invention, the particular controller calls the inventive software module when it receives transaction information. Alternately, the inventive software module may monitor one or more other software modules to detect asset transactions.

In any event, the module is invoked, and each transaction moves through the hierarchical sequence of queries until the transaction correlates to the criteria of one of the queries and the corresponding audit is called. In a preferred embodiment, the queries corresponding to the more specific audits occur in the early part of the routine, and the queries corresponding to the more general audits occur toward the bottom of the routine. The hierarchy may be based simply on the historical average percentage of assets of the given company that fall within each of the specific audits. Of course, the particular audits also would be customized to the particular corporation or other entity using the invention. When the asset matches the criteria for calling an audit, the query process generally is halted and no attempts to correlate the asset to any audits lower in the hierarchy are performed. However, as previously noted, in some embodiments, the routine may allow a return to the hierarchy after an audit is called and that audit cannot derive a location for the asset, if the condition that precipitated the failure to derive a tax location is not necessarily an error that needs correction. Rather, the failure to derive a location may be the result of selecting audit incorrectly, where a subsequent audit in the hierarchy may still be able to successfully derive a location, if given the opportunity.

In FIG. 1, each block 120, 125, 130, 135, 140, 145, 150, 155, 160, 165, 170, and 175 corresponds to one of the queries to correlate the asset to an appropriate audit, based on criteria such as asset type or transaction type (as will be discussed further below) as well as the corresponding audit logic for attempting to derive a tax location for the asset.

For exemplary purposes, we shall assume that the corporation using the present invention classifies most assets as one of four location types for tax location purposes. The most common location type might be termed an “internal asset” (hereinafter a type I asset), which refers to an asset that typically is located at an internal location of the company and not typically given or loaned to vendors or customers. Such assets might include furniture, desk top computers or work stations, and manufacturing equipment. Another asset location type might be a vendor asset (hereinafter a type V asset). This category might include fixed assets that commonly are found at a vendor's sight. Such assets might include inventory that is stored off-site or products that are in the process of manufacture wherein one or more stages of the manufacturing process occur at a vendor's off-site location. Another asset location type might be Customer (hereinafter asset type C). This type might encompass assets that typically are found at the physical location of a customer of the corporation. Such assets might include products used frequently for servicing equipment or machines manufactured by the corporation that require frequent service.

Another asset location type might be a Loaner (hereinafter asset type L). These types of assets might encompass assets that are commonly loaned to different persons at different locations within the company or without the company and might be located at various different locations during their lifetime, but remain in each particular location for a reasonably extended period of time. Such asset might include company cars and laptop computers.

As will be seen in the discussion below, these asset location type codes can be used to help derive a tax location for the asset.

Referring now to FIG. 1, upon invocation, the software module 100 starts at step 120. In step 120, the module might first attempt to determine if the asset meets the criteria to classify the transaction as a return to plant transaction. If a successful match is made on this criteria, then the module 100 will call the return to plant audit, which audit will attempt to assign a tax location based on the logic within that audit.

For instance, corporations may have assets that are loaned out and subsequently returned to the plant for redeployment or scrap. Accordingly, the first task performed in block 120 is to run a query on the data in the transaction record (and possibly data available from other sources, such as databases and table) to determine whether the transaction record or other data contains information disclosing that the transaction is a return of the asset to a corporate plant. If not, the process will flow to the next query in step 125. If the transaction is a return to plant transaction, then the return to plant audit will be called and will run through a routine comprising one or more inquiries of the transaction record provided to it by the calling controller module and/or other available data such as might be available in one of more databases or tables to attempt to determine the appropriate tax location for the asset. Merely as an example, let us assume that the corporation maintains a plant code in a database indicating the home plant for certain kinds of assets. Accordingly, if the transaction is determined to be a return to plant transaction, the logic might consult a database or table that discloses that asset's home plant. The home plant might be indicated in the table by work location and building number. If a home plant work location and building number is found for the asset, then the logic consults the same or another database or table that correlates all of the work location and building numbers of the corporation to tax jurisdictions. Once the tax jurisdiction is determined, the tax jurisdiction code may be updated in the same or a different database or table and the location type for the asset record set to I. If, on the other hand, the logic cannot correlate a work location and building number to the asset (e.g., the work location and building number field in the database is not populated for that asset or contains an invalid or non-parsable value) or cannot correlate a tax jurisdiction to the work location and building number (e.g., the tax jurisdiction code field in the database is not populated for that asset or contains an invalid or non-parsable value), an error message is generated as shown at step 185. If, on the other hand, the logic completes successfully, the process instead flows to step 180 where the tax jurisdiction code (and any other relevant data) is returned to the calling controller.

If the transaction is not a return to plant transaction, flow simply proceeds from step 120 to 125 to the next query. In step 125, the logic attempts to determine if the asset is a rental asset, as might be indicated by an asset class code associated with the asset in the transaction record or a corporate database. This might be provided as part of the transaction record provided to the logic by the calling controller software or alternately may be retrieved from a database or table. If it is a rental asset, the logic of step 125 will attempt to derive the tax location code using the customer number already assigned to the asset or input as part of the transaction that initiated the call to the module. This customer number will be correlated to the appropriate customer table and the tax location corresponding to the customer number will be assigned to the asset. The location type is set to C (for customer's site) in the appropriate table or database and for the tax jurisdiction code returned to the calling controller in step 180. If one or more of these steps cannot be completed successfully, the logic errors out and flow proceeds instead to step 185. If the asset is not a rental asset, then flow simply proceeds from step 125 to step 130 to perform the next query.

The next three logic blocks 130, 135 and 140 relate to three common exemplary kinds of asset. For instance, step 130 relates to lot cap (lot capitalization) assets. These are assets that are capitalized for tax and insurance value reporting as a group. For instance, if a company buys five hundred desks at one time, it typically will capitalize them together. Accordingly, the logic in the lot cap block 130 will first determine if the asset is a lot cap asset (as might be indicated by a field in a database, and, if so, consult a table or database that indicates where the particular desk was to be shipped (e.g., a SHIP-TO table) to and then retrieve the work location and building number based on the ship to data and then retrieve the proper tax jurisdiction code for that work location and building and finally set the asset location type to I.

In step 135, if the asset is determined to be a warehouse asset, then a different set of logic steps would be used to determine, if possible, a tax jurisdiction code.

If the asset is land or a building (step 140), then a different set of inquiries customized to real property type assets is performed to attempt to derive a tax jurisdiction code for the asset.

In any given logic block, the particular logic that is run will be customized to some characteristic of the asset or transaction, such as the kind or type of the asset or the nature of the transaction. The particular logic run to correlate an asset with a tax location is dependent on the types of information the company maintains in one or more databases or table as well as the particular desires of the company.

Step 145, on the other hand, pertains to a different type of audit for determining a tax jurisdiction and thus will be discussed in some detail. However, again, it should be understood that it is merely exemplary. Thus, if an asset runs through steps 120, 125, 130, 135, and 140 without the asset correlating to one of the audits, then the software module attempts to assign a tax jurisdiction to the asset based on the value in the asset location type field. Thus, if the record includes a validly populated asset location type field (value I, C, V, or L, as discussed above), the logic in block 145 will attempt to retrieve a tax jurisdiction code from an appropriate table/database (the appropriate table/database depending on the asset location type. If this is completed successfully, flow proceeds to step 180. If an asset location type match is found, but a tax jurisdiction code cannot be located, then the logic errors out and process instead flows to step 185.

If no asset type is assigned, flow continues down the hierarchy to step 150. Step 150 determines if the asset is data processing equipment. This category usually consists of high end computer equipment such as servers and storage devices which typically have high values. The audit logic for determining the tax location for data processing equipment is customized for that kind of equipment. If a customer number has been assigned to the asset, it is first used to determine the tax location. The audit logic attempts to check the appropriate table that correlates the customer number to a tax jurisdiction and, if successful, the return the tax jurisdiction code to the calling controller (step 180). If a valid customer number has not been assigned to the asset, then the audit proceeds through the remainder of the data processing equipment audit logic, which includes looking up the owning employee in an HR database to attempt to retrieve the work location and building assigned to that employee, and then attempt to correlate the work location and building number to the appropriate tax location code using a table or database that correlates the work location and building numbers to tax jurisdictions.

If the process flows through all of steps 120 through 150 without correlating to the query criteria for calling one of the corresponding audits, then, in step 155, the module 100 attempts to correlate the asset to a tax jurisdiction by its work location and building number, if one is assigned. Thus, if a valid work location and building number is assigned to the asset in the appropriate database and a tax jurisdiction code is available for that work location and building number, a correlation is determined and flow proceeds to step 180, in which the tax jurisdiction code is returned to the calling controller. If, on the other hand, the asset has an assigned work location and building number, but the work location and building number are not valid, the audit goes through a few more inquiries and if it still cannot derive a tax location, then flow proceeds to step 185 to generate an error message. Finally, if no work location and building number are assigned, flow will simply proceed down to step 160.

In step 160, the logic determines if an employee serial number is assigned to the asset. If so, if attempts to determine the work location and building number for the employee and then the tax jurisdiction code for that work location and building number. As with all previous audits, if successful, flow proceeds to step 180; and, if unsuccessful, flow proceeds to step 185. If there is no assigned employee serial number, flow then proceeds to step 165.

The logic corresponding to step 165 attempts to determine if the asset has an assigned customer number. If so, it runs through a process to attempt to associate the customer number with a tax jurisdiction by consulting with the appropriate table(s)/database(s). If successful, flow proceeds to step 180; and, if unsuccessful, flow proceeds to step 185.

If there is no assigned customer number, then flow proceeds to the last step 170 in a last ditch effort to associate the asset with a tax jurisdiction using a cost center database. Merely as an example, the logic might (1) attempt to determine if a cost center field in an appropriate database is populated with a valid value and, if so, (2) determine the employee serial number of the manager of that cost center, (3) retrieve the work location and building number for that individual, and then (4) retrieve the tax jurisdiction code assigned to that work location and building number. If that is unsuccessful, there may be a default building number or tax jurisdiction code for the cost center. If successful, flow proceeds to step 180; and, if unsuccessful, flow proceeds to step 185. For this last query 170, flow will proceed to step 185 for generation of an error message if either no cost center is assigned or one is assigned, but a tax jurisdiction cannot be derived, since there are no more checks to be performed.

Those of skill in the art will recognize that the foregoing embodiment is merely exemplary and that the particular audits and the queries corresponding to each audit will depend on many factors, including the accounting practices of the particular tax paying and/or insured entity. It will be understood by those of skill in the art that the software module of the present invention utilizes a series of hierarchical queries to attempt to classify the asset or transaction into one of a plurality of categories, and, if it can do so, it then runs an audit of the available data for that asset to derive a tax jurisdiction, the specific inquiries customized for that asset type. The inquiries may be of data available in the transaction record that the calling controller provides to the module 100 and/or other data available from other asset databases and tables. Also of significance is the fact that the module is invoked responsive to every transaction (transfer or capitalization) involving an individual asset. This helps prevent a large back log of tax jurisdiction data problems from arising between the fixed intervals at which tax and/or insurance reports are generated. It also helps minimize the existence of undetected errors in the assigned tax jurisdiction for assets.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

We claim:

1. A method of tracking the location of capitalized fixed assets for tax and/or insurance reporting purposes, said method comprising the steps of:
(1) detecting when a capitalized fix asset is involved in a transaction;
(2) responsive to such a detection in step (1), running data for said asset through a plurality of queries, each query designed to determine if said asset meets a set of criteria indicative of a category of how a location of said asset may be determined;
(3) if, in step (2), said asset meets said set of criteria corresponding to one of said queries, running data corresponding to said asset through an audit customized to said corresponding category to determine a location of said asset;
(4) if, in step (3) a location is determined, assigning said determined location to said asset for tax and/or insurance reporting purposes;
(5) if, in step (3), a location is not determined issuing an error notification; and
(6) if, in step (2), if said data for said asset does not meet said criteria of any of queries, issuing an error notification.

2. The method of claim 1 wherein, in step (2), each of said sets of criteria comprises at least one criterion to which said data for said asset must match.

3. The method of claim 2 wherein, in step (2), said data for said asset is run through said plurality of queries hierarchically, wherein, when said asset meets said set of criteria of a particular query, said asset data is not run through any queries ordered lower in said hierarchy.

4. The method of claim 3 wherein said transaction comprises a transfer or capitalization.

5. The method of claim 3 wherein said error notification issued in step (5) indicates that the asset met said set of criteria corresponding to one of said categories, but was not assigned a location.

6. The method of claim 5 wherein said error notification issued in step (5) further indicates which of said at least one criterion caused said error.

7. The method of claim 5 wherein said error notification issued in step (6) indicates that said asset data did not meet said criteria corresponding to any category.

8. A computer readable product embodied on computer readable media readable by a computing device for tracking the location of capitalized fixed assets for tax and/or insurance reporting purposes, said product comprising computer executable instructions for:
(1) interfacing with external software to become aware of when a capitalized fixed asset is involved in a transaction;
(2) responsive to such a detection in step (1), accessing data for said asset and running said data through a plurality of queries, each query designed to determine if said asset meets a set of criteria indicative of a category of how a location of said asset may be determined;
(3) if, in step (2), said asset meets said set of criteria corresponding to one of said queries, running data corresponding to said asset through an audit customized to said corresponding category to determine a location of said asset;
(4) if, in step (3) a location is determined, assigning said determined location to said asset for tax and/or insurance reporting purposes;
(5) if, in step (3), a location is not determined issuing an error notification; and
(6) if, in step (2), if said data for said asset does not meet said criteria of any of queries, issuing an error notification.

9. The computer readable product of claim 8 wherein instruction (4) further comprises instructions for transmitting said determined location to said external software.

10. The computer readable product of claim 8 wherein, in instruction (2), each of said queries comprises at least one criterion to which said data for said asset must match.

11. The computer readable product of claim 10 wherein, in instruction (2), said data for said asset is run through said plurality of queries hierarchically, wherein, when said asset meets set of criteria of a particular query, said asset data is not run through any queries ordered lower in said hierarchy.

12. The computer readable product of claim 11 wherein said transaction comprises a transfer or capitalization.

13. The computer readable product of claim 11 wherein said error notification issued by instruction (5) indicates that the asset met said set of criteria corresponding to one of said categories, but was not assigned a location.

14. The computer readable product of claim 13 wherein said error notification issued by instruction (5) further indicates which of said at least one criterion caused said error.

15. The computer readable product of claim 13 wherein said error notification issued by instruction (6) indicates t hat said asset did not meet said criteria corresponding to any category.

16. The computer readable product of claim 8 wherein instruction (1) comprises detecting a call from said external software.

17. The computer readable product of claim 8 wherein instruction (1) comprises monitoring said external software to detect a transaction involving an asset.

18. The computer readable product of claim 8 wherein instruction (3) comprises accessing said data corresponding to said asset from at least one of a database and a transaction record received from said external software.

19. A computer system having at least one memory for storing data and at least one central processing unit for executing instructions, said memory storing at least one database containing data about a plurality of capitalized fixed assets, said central processing unit adapted to track the location of capitalized fixed assets for tax and/or insurance reporting purposes, said computer system comprising means for recording transactions relating to capitalized fixed assets, said system further comprising:
means for interfacing with external software to become aware of when a capitalized fixed asset is involved in a transaction;
means responsive to said detection for accessing data for said asset and running said data through a plurality of queries, each query designed to determine if said asset meets a set of criteria indicative of a category of how a location of said asset may be determined;
means for running data corresponding to said asset through an audit customized to said corresponding category to determine a location of said asset, if said asset meets said set of criteria corresponding to one of said queries;
means for assigning said determined location to said asset for tax and/or insurance reporting purposes and transmitting said determined location to said controller software, if a location is determined;
means for issuing an error notification, if a location is not determined; and
means for issuing an error notification an asset type is not determined for said asset.

20. The computer system of claim 19 wherein each of said queries comprises at least one criterion to which said data for said asset must match.

21. The computer system of claim 20 wherein said data for said asset is run through said plurality of queries hierarchically, wherein, when said asset meets set of criteria of a particular query, said asset data is not run through any queries ordered lower in said hierarchy.
